(19) United States
(12) Patent Application Publication
(10) Pub. No.: US 2004/0228227 A1
(43) Pub. Date: Nov. 18, 2004

(54) Disk loading device

(75) Inventors: Yuji Morita, Saitama (JP); Yoshimitsu Fukushima, Saitama (JP); Hitoshi Nagata, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/841,490

(22) Filed: May 10, 2004

(30) Foreign Application Priority Data
May 13, 2003 (JP) P.2003-134613

(51) Int. Cl. G11B 7/085

(52) U.S. Cl. 369/30.36

(57) ABSTRACT

A clamp means of a disk loading device has a turntable, a clamper, and a supporter for restricting a rotational range of a clamper holder. The supporter is connected to a lower surface of the clamper holder, and a distal end of the supporter extends to a position above a top plate (fixing member) provided in a housing. Therefore, the turntable can be stably pulled from the clamper, and the disk loading device can be made compact.

### BACKGROUND OF THE INVENTION

1. Field of the Invention

The present invention relates to a disk loading device.

2. Description of the Related Art

As shown in FIG. 1, a cartridge body 100 for accommodating a disk such as a DVD-RAM in a cartridge is arranged such that a disk 101 is accommodated in a cartridge 102 to protect an information recording surface (a lower surface in FIG. 1) of the disk 101.

The cartridge 102 is formed in the shape of a substantially hollow thin box, and an opening 103 provided in such a manner as to extend along the radial direction of the disk 101 from a central portion of the cartridge 102 is closed by a shutter 104. As the shutter 104 is opened, the information recording surface of the disk 101 is capable of being exposed to the outside.

FIG. 2 schematically shows a general configuration of a recording/reproducing apparatus for reproducing (reading) or recording (writing) information by accessing the information recording surface of the disk 101 in such a cartridge body 100 (e.g., refer to patent document 1).

A recording/reproducing apparatus 200 shown in FIG. 2 has a housing 201, a pickup unit 202 incorporated in the housing 201, a drive unit 203 for rotatively driving the disk 101, and a cartridge disk loading device 300.

The cartridge disk loading device 300 has a tray 301, an advancing/retracting means (not shown), a lifting means 303, and a clamp means 304. The tray 301 is supported by the housing 201 and on which the cartridge 102 of the cartridge body 100 can be loaded. The advancing/retracting means advances or retracts the tray 301 in the left-and-right direction in FIG. 2 with respect to the housing 201. The lifting means 303 lifts the cartridge 102 to a predetermined height from the tray 301 in a state that the tray 301 is accommodated in the housing 201. The clamp means 304 clamps and holds a circular center portion of the disk 101 in its thicknesswise direction in the state that the tray 301 is accommodated in the housing 201.

This tray 301 is capable of being advanced and retracted between an access position and a replacement position by the advancing/retracting means such as a motor operated through the medium of such as a rack and a pinion.

The access position refers to a position (the state shown in FIG. 2C) where in the state that the tray 301 is accommodated in the housing 201, the pickup unit 202 effects reproduction in the case of a reproducing apparatus, effects recording in the case of a recording apparatus, and effects recording and reproduction in the case of a recording/reproducing apparatus with respect- to the information recording surface of the disk 101. Meanwhile, the replacement position refers to the position (the state shown in FIG. 2A) where the tray 301 projects from the housing 201 to allow a user to replace the cartridge body 100.

Hereafter, the portion oriented in the direction toward the replacement position will be referred to as the “front portion,” and the portion oriented in the direction toward the access position will be referred to as the “rear portion.”

The lifting means 303 has a lifting member 306 disposed so as to be located on the reverse surface side of the tray 301 in the state that the tray 301 is disposed at the access position.

The lifting member 306 is formed substantially in the shape of a plate, and rotates about its rear portion side (the left side in FIG. 2) inside the housing 201 such that its front portion side (the right side in FIG. 2) moves vertically, thereby approaching or moving away from the tray 301. The pickup unit 202 and the drive unit 203 such as the motor are supported on the lifting member 306.

The clamp means 304 is shown in FIGS. 3 and 4. In these drawings, the right-hand side is the rear portion side, and the left-hand side is the front portion side.

The clamp means 304 has a dish-like turntable 304A attached to a rotating shaft of the drive unit 203 such as the motor, and a clamper 304B attached to a ceiling surface of a fixing member 312 through a clamper holder 310. As for the turntable 304A and the clamper 304B, a magnet is incorporated in one of them, and a magnetic metal is incorporated in the other. The arrangement, provided is such that the turntable 304A and the clamper 304B are capable of clamping the circular center portion of the disk 101 in its thicknesswise direction by repeating the attraction to and movement away from each other.

As for the clamper holder 310 for supporting the clamper 304B, only one end 310B side is vertically movable with respect to the fixing member 312 to allow the clamper 304B to move vertically. The clamper holder 310 vertically moves the clamper 304B by vertically rotating the other end 310B side with a fulcrum on one end 310A side as an axis.

As the lifting member 306 of the lifting means 303 rotates when the tray 301 has moved to the access position, this clamp means 304 moves the turntable 304A toward the tray 301, thereby allowing the turntable 304A to push the circular center portion of the disk 101 upwardly.

Then, as shown in FIG. 4, at the same time as the turntable 304A pushes up the disk 101 to a predetermined height, the clamper holder 310 rotates to the turntable side about a rotating shaft (not shown) by an unillustrated rotating mechanism, thereby causing the clamper 304B and the turntable 304A to approach each other gradually. The clamper 304B and the turntable 304A are attracted to each other by a magnetic force and hold the disk 101. Subsequently, the clamper holder 310 leaves the clamper 304B attracted to and stopped at the turntable 304A, rotates further, and stops, securing a clearance permitting rotation between thee clamper holder 310 and the clamper 304B.

FIG. 3 shows a state in which the cartridge body 100 is capable of being loaded.

The other end 310B of the clamper holder 310 is a free end, as shown in FIGS. 3 and 4. A retaining portion 311 is provided in advance at the free end 310B of the clamper holder 310. When the clamper holder 310 is rotated, the retaining portion 311 having a substantially crank-shaped cross section is placed on the flat fixing member 312 (the state shown in FIG. 4), and the free end 310B of the clamper holder 310 is supported by the fixing member 312.

FIG. 4 shows a state of the disk loading device 300 at the time of recording/reproduction. After recording/reproduction is finished, the clamping of the disk 101 is canceled, and the turntable 304A is lowered so as to secure a clearance for allowing the cartridge 102 to be unloaded in the back-and-forth direction.

At this time, the clamper 304B is lowered together with the turntable 304A by means of the attracting force, and clamper 304B abuts against the clamper holder 310 and tends to lower the clamper holder 310.

However, since the retaining portion 311 of the clamper holder 310 is placed on the fixing member 312 to support the free end 310B side of the clamper holder 310 by the fixing member 312, the load at the time of pulling the turntable 304A off the clamper 304B is stably received by the fixing member 312, blocking the lowering of the clamper 304B.

Then, if the turntable 304A is further lowered, the turntable 304A is positively pulled off the clamper 304B. Subsequently, the clamper holder 310 is returned to its initial position by the unillustrated rotating mechanism, so that the clamper 304B is lifted by following the clamper holder 310 and is returned to the state shown in FIG. 3.

As shown in FIG. 3, the clamper 304B is lifted together with the clamper holder 310, and the lower end portion of the clamper 304B is lifted to an upper position for positioning the cartridge body 100 to secure a loading space, so that the cartridge body 100 will not interfere with the clamper 304B at the time of loading the cartridge body 100.

JP-A-9-91821 is referred to as a related art.

Since the retaining portion 311 is provided on the free end 310B side of the clamper holder 310 of the above-described loading device 300 shown in FIGS. 3 and 4. Therefore, if the clamper holder 310 is lifted to a position for securing the loading space, the retaining portion 311 projects upwardly by a large degree.

Thus, it is inevitable to form the housing 201 such that the retaining portion 311 does not project. As a result, there is a limit to make the disk loading device 300 compact.

The configuration shown in FIGS. 5 and 6 is also known as a method for supporting the free end of the clamper holder.

In this configuration, a retaining portion 314 having a substantially crank-shaped cross section is provided at the fixing member 312, and the free end 310B of the clamper holder 310 is placed on the retaining portion 314 of the fixing member 312 so as to support the free end 310B of the clamper holder 310 by the retaining portion 314 of the fixing member 312.

As the free end 310B of the clamper holder 310 is placed on the retaining portion 314 of the fixing member 312 to support the clamper holder 310 by the retaining portion 314 of the fixing member 312, the load at the time of pulling the turntable 304A off the clamper 304B is stably received by the fixing member 312, blocking the lowering of the clamper 304B.

Further, as shown in FIG. 6, the clamper 304B is lifted together with the clamper holder 310, and the lower end portion of the clamper 304B is lifted to an upper position for positioning the cartridge body 100 to secure a loading space, so that the cartridge body 100 will not interfere with the clamper 304B at the time of loading the cartridge body 100.

As for the disk loading device 300 shown in FIGS. 5 and 6, since the retaining portion 314 having a substantially crank-shaped cross section is provided downwardly at the fixing member 312. Therefore, if the ceiling surface of the housing 201 is lowered to make the device compact, it is inevitable to lower the fixing member 312 as well.

However, there is a limit to make the device compact because it is necessary to secure a clearance required between the downwardly provided retaining portion 314 and the cartridge body 100.

### SUMMARY OF THE INVENTION

An object of the invention is to make compatible the structure for stably receiving the load at the time of pulling the turntable off the clamper and the structure for making the cartridge disk loading device compact.

The invention provides a disk loading device having: a tray having a mounting surface capable of mounting a disk thereon and supported by a housing of a recording and/or reproducing apparatus; and a clamp unit which holds the disk at a predetermined height at a position where said tray is accommodated in said housing, said clamp unit having a turntable for lifting a circular center portion of the disk from below, a clamper supported by said housing through a clamper holder provided in said housing and adapted to move away from or attract said turntable by being lifted or lowered as said clamper holder rotates with respect to said housing, and a supporter connected to said clamper holder and adapted to abut on a fixing member provided in said housing, wherein said supporter restricts a rotational range of said clamper holder.

The disk loading device of the invention is applicable not only to a recording/reproducing apparatus for effecting reproduction and recording with respect to an information recording surface of a disk in a cartridge body, but also to a reproducing apparatus for effecting only reproduction or a recording apparatus for effecting recording.

In addition, the supporter included in the disk loading device suffices if it is formed in a crank shape, for example. The supporter may be formed in the shape of a flat plate by appropriately setting the shapes of the clamper holder and the fixing member or their positional relationship.

Further, the supporter is formed of a resiliently deformable plate material, so that the clamper holder can be further lifted in the state that the supporter is kept stationary at the position of its abutment against the housing. Accordingly, the clamper can be lifted to a predetermined position by the clamper holder without causing the supporter to project from the housing.

### BRIEF DESCRIPTION OF THE DRAWINGS

FIG. 1 is a perspective view illustrating a general cartridge body;

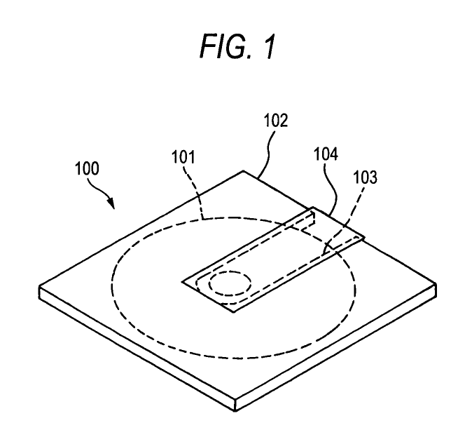

FIGS. 2A-2C are schematic cross-sectional views illustrating a conventional cartridge disk loading device;

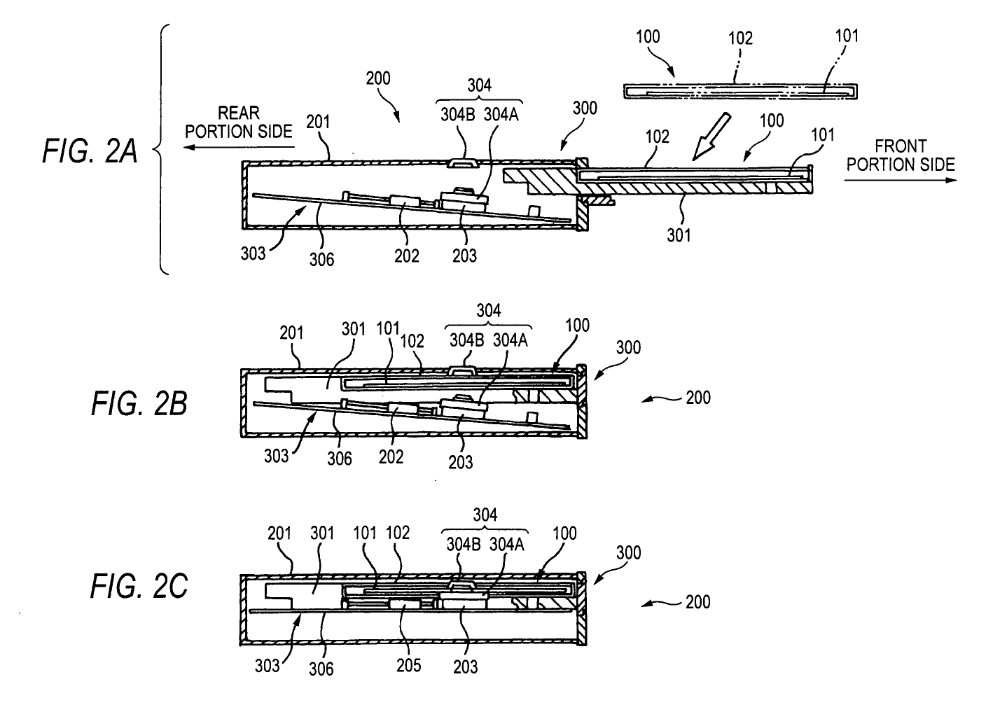

FIG. 3 is a cross-sectional view illustrating a state of recording or reproduction by the conventional cartridge disk loading device;

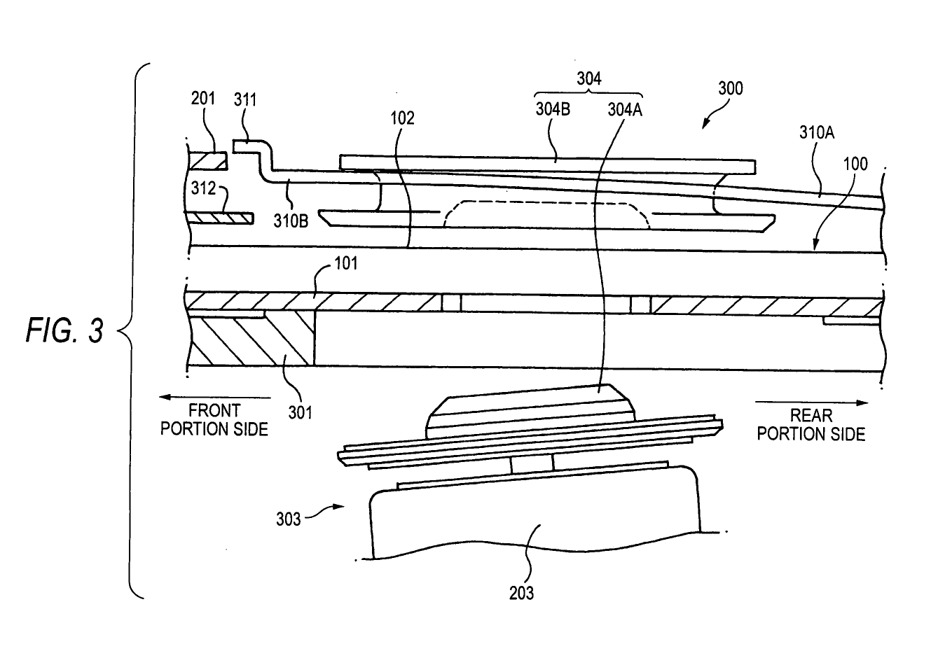

FIG. 4 is a cross-sectional view illustrating a state in which a loading space is secured in the conventional cartridge disk loading device;

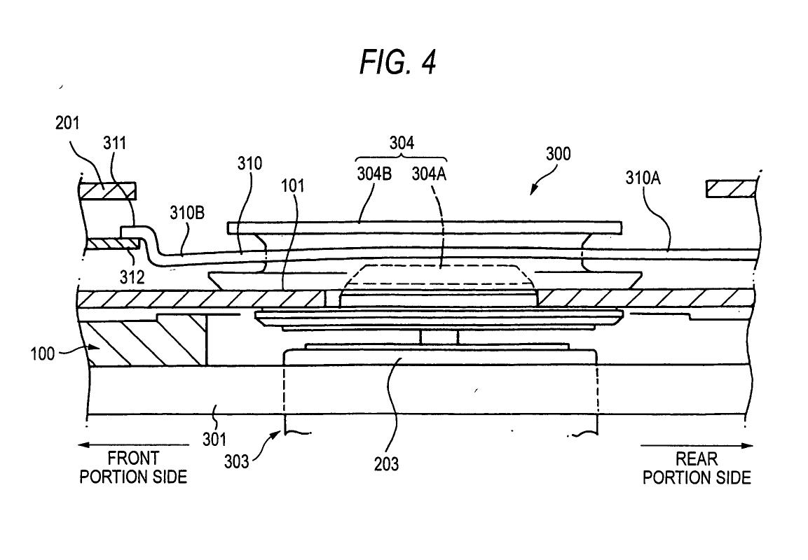

FIG. 5 is a cross-sectional view illustrating a state of recording or reproduction by a conventional cartridge disk loading device of another type;

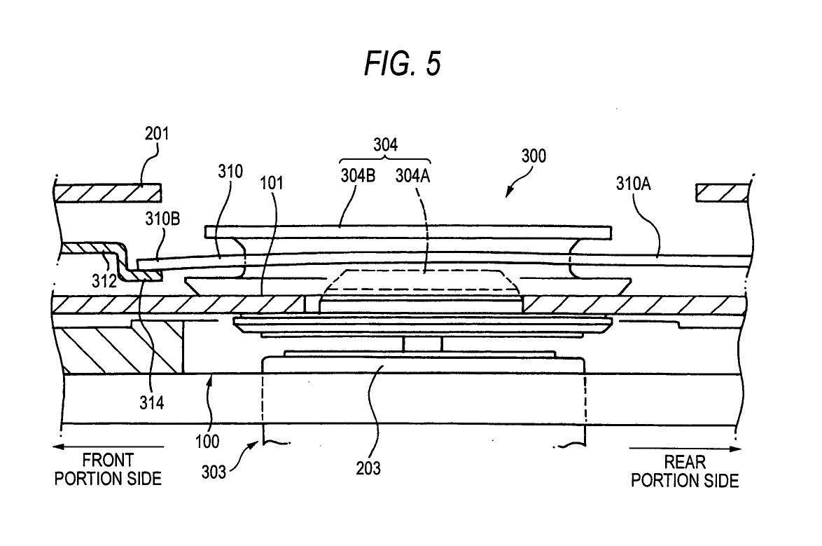

FIG. 6 is a cross-sectional view illustrating a state in which a loading space is secured in the conventional cartridge disk loading device of the other type;

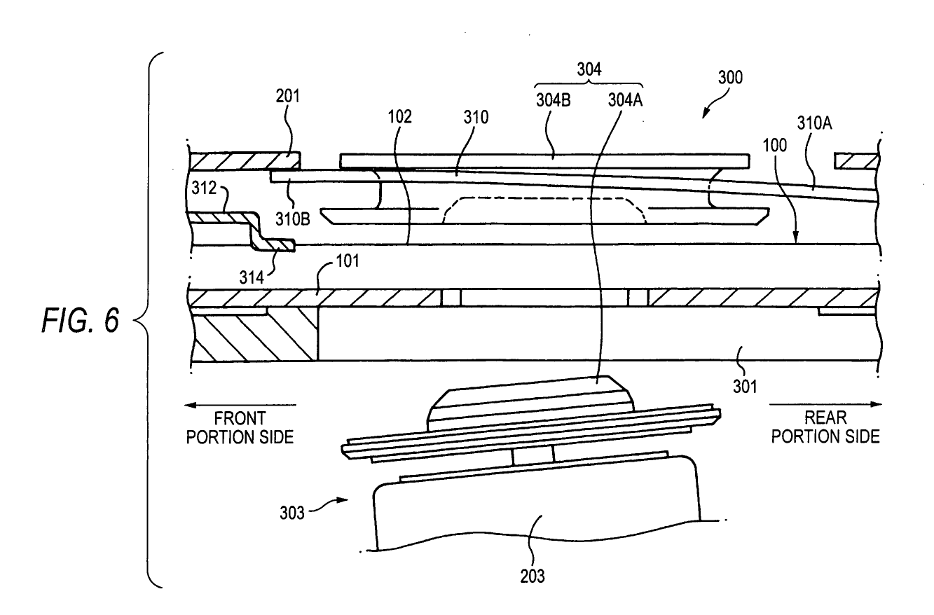

FIG. 7 is a perspective view illustrating an overall configuration of an embodiment in accordance with the invention;

FIG. 8 is an exploded perspective view illustrating the overall configuration of the embodiment in accordance with the invention;

FIG. 9 is a cross-sectional view illustrating an access position of the cartridge disk loading device in accordance with the embodiment of the invention;

FIG. 10 is a cross-sectional view illustrating an access state in accordance with the embodiment of the invention; and

FIG. 11 is a cross-sectional view illustrating a state in which a turntable is pulled off a clamper in accordance with the embodiment of the invention.

### DETAILED DESCRIPTION OF THE PREFERRED EMBODIMENTS

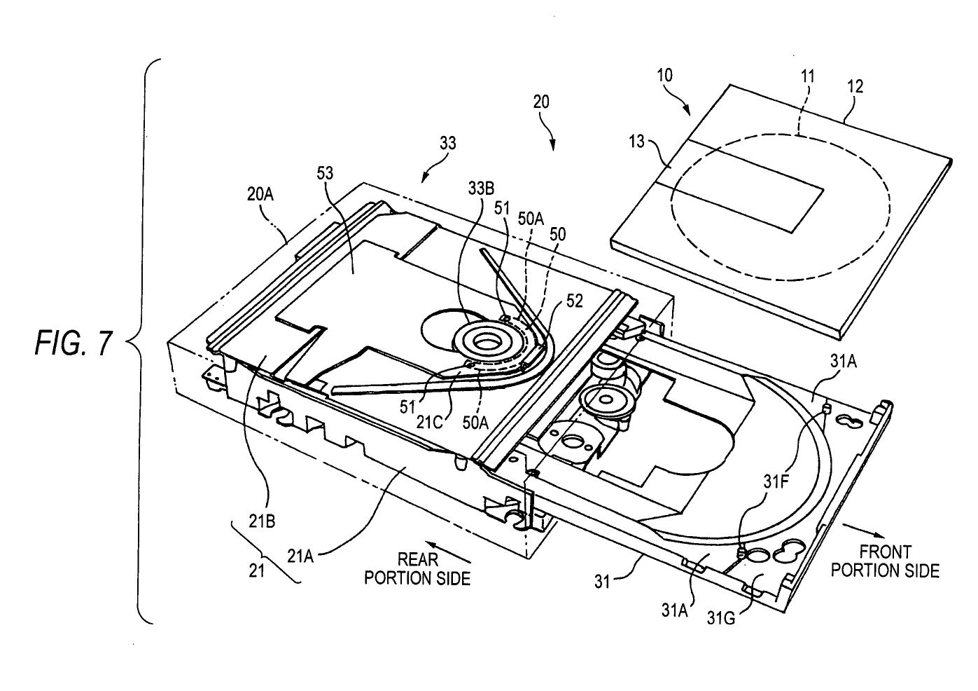

An Embodiment of the invention will be described with reference to FIGS. 7 to 11.

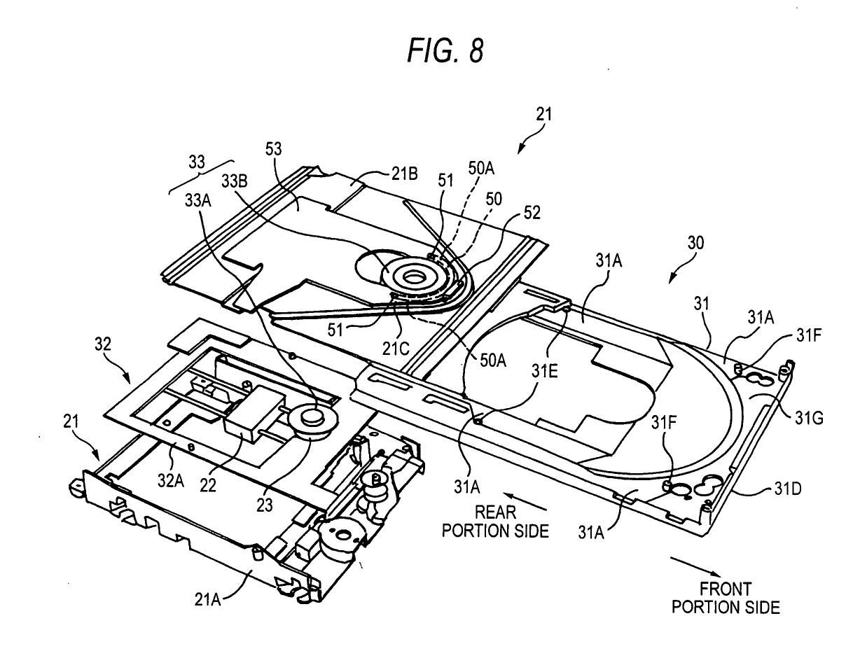

FIGS. 7 and 8 show a recording/reproducing apparatus 20 in accordance with an embodiment of the invention. Namely, FIG. 7 is an overall perspective view of the recording/reproducing apparatus 20 and a cartridge body 10 with a disk 11 accommodated in a cartridge 12. FIG. 8 is an exploded perspective view of the recording/reproducing apparatus 20.

As for the cartridge body 10, a shutter 13 is opened or closed as a lever (not shown) provided on a side end surface of the cartridge 12 is operated. As the shutter 13 is opened, the information recording surface of the disk 11 in the cartridge body 10 is exposed to the outside.

The recording/reproducing apparatus 20 effects the reproduction (reading) or recording (writing) of information by accessing the information recording surface of the disk 11 in the cartridge body 10.

As shown in FIG. 7, the recording/reproducing apparatus 20 has a housing 21 accommodated in a cover 20A. The housing 21 has a loading base 21A and a top plate 21B as fixing members combined substantially in a box shape. One end of a clamper holder 53 opposite to a supporter 50 is fixed to the top plate 21B. The clamper holder 53 is arranged to be rotatable about an unillustrated rotating shaft in the direction of being attracted to or removed from a turntable 33A. The clamper holder 53 is provided with a clamper 33B of a clamp means 33 which will be described later.

As shown in FIG. 8, the recording/reproducing apparatus 20 has a pickup unit 22 incorporated in the housing 21, a drive unit 23 such as a motor for rotatively driving the disk 11, and a disk loading device 30.

The disk loading device 30 has a tray 31 which is supported by the housing 21 and has a plurality of mounting surfaces 31A on which the cartridge body 10 can be mounted in a state of surface contact therewith. The disk loading device 30 is configured such that the cartridge body 10 is lifted to a predetermined height by a lifting member as a lifting means 32 from the mounting surface 31A of the tray 31, and the disk 11 in the cartridge body 10 is clamped and held in its thicknesswise direction by the clamp means 33.

In the disk loading device 30, a pinion gear, which is rotatively driven by a motor incorporated in the housing 21, meshes with a rack fixed to the tray 31. As the motor is driven, the tray 31 is moved from the access position to the replacement position. At the access position, the cartridge body 10 is lifted from the mounting surface 31A of the tray 31 to a predetermined height, and the disk 11 is lifted to and held at a position where it does not come into contact with inner wall surfaces of the cartridge 12 of the cartridge body 10. The information recording surface of the disk 11 is thereby disposed with respect to the pickup unit 22.

The access position refers to a position where in the state that the tray 31 is accommodated in the housing 21, the pickup unit 22 effects reproduction in the case of the reproducing apparatus, effects recording in the case of the recording apparatus, and effects recording and reproduction in the case of a recording/reproducing apparatus with respect to the information recording surface of the disk 11. Meanwhile, the replacement position refers to a position where the tray 31 projects from the housing 21 to allow the user to replace the cartridge body 10.

Hereafter, the portion oriented in the direction toward the replacement position will be referred to as the “front portion,” and the portion oriented in the direction toward the access position will be referred to as the “rear portion.”

As shown in FIG. 8, as for the lifting means 32, the drive unit 23 is fixed to the rim of an opening provided in a substantially central portion of a lifting member 32A formed substantially in the shape of a plate.

As the lifting member 32A rotates about a supporting shaft extending in a direction perpendicular to the advancing/retracting direction of the tray 31 on the rear portion side (innermost portion side) inside the housing 21, the front portion side approaches or moves away from the reverse surface of the tray 31.

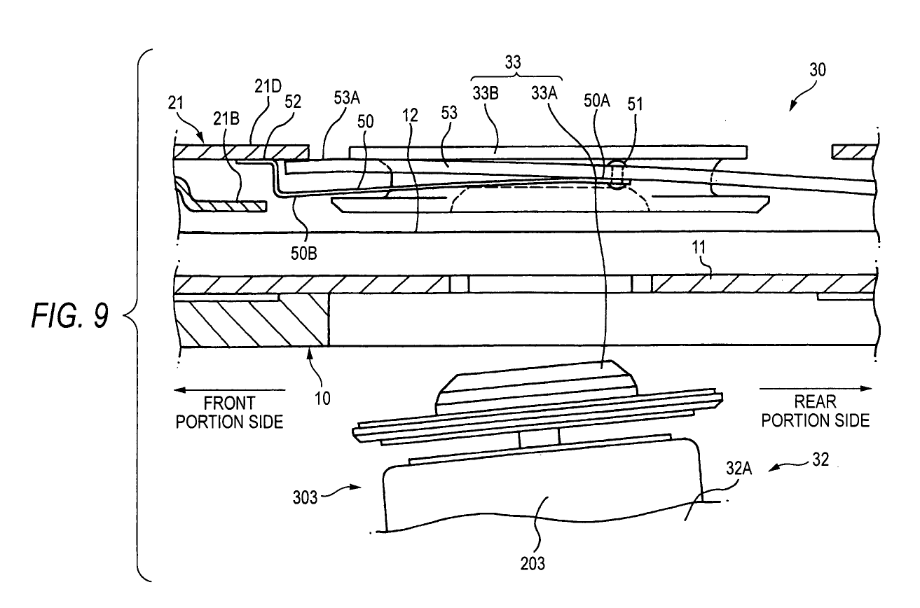

As also shown in FIGS. 9 to 11, in the same way as the conventional one, the clamp means 33 has the dish-like turntable 33A attached to the rotating shaft of the drive unit 23, and the clamper 33B attached through the clamper holder 53.

A magnet is incorporated in one of the turntable 33A and the clamper 33B. The other of the turntable 33A and the clamper 33B is made of a magnetic metal. The turntable 33A and the clamper 33B are capable of clamping the disk 11 in its thicknesswise direction by repeating the attraction to and movement away from each other.

At a distal end portion 53A of the clamper holder 53 making up the clamp means 33, a curved supporter (restricting means) 50 is disposed along an outer periphery of the clamper 33B. Proximal end portions (both ends) 50A of the supporter 50 formed in a circular arc shape are fixed to the clamper holder 53 by screws 51, for example.

A retaining portion 52, which can be retained by the top plate 21B, is provided at a distal end of the supporter 50 for restricting the rotational range of the clamper holder 53. As the retaining portion 52 is provided at the distal end of the supporter 50, the supporter 50 is formed with a substantially crank-shaped cross section.

The supporter 50 is formed of a plate-shaped spring material, and its proximal end portions (both ends) 50A (see FIGS. 7 and 8) are fixed to the clamper holder 53 by the screws 51, for example, while its distal end 50B is urged so as to come into pressure contact with the clamper holder 53 by its own spring force.

A description will be given of the operation of the above-described embodiment with reference to FIGS. 9 to 11.

First, a user mounts the cartridge body 10 on the tray 31 at the replacement position, to move the tray 31 to the access position either by pushing the tray 31 into the housing 21 or by operating an advance/retract switch (the state shown in FIG. 9).

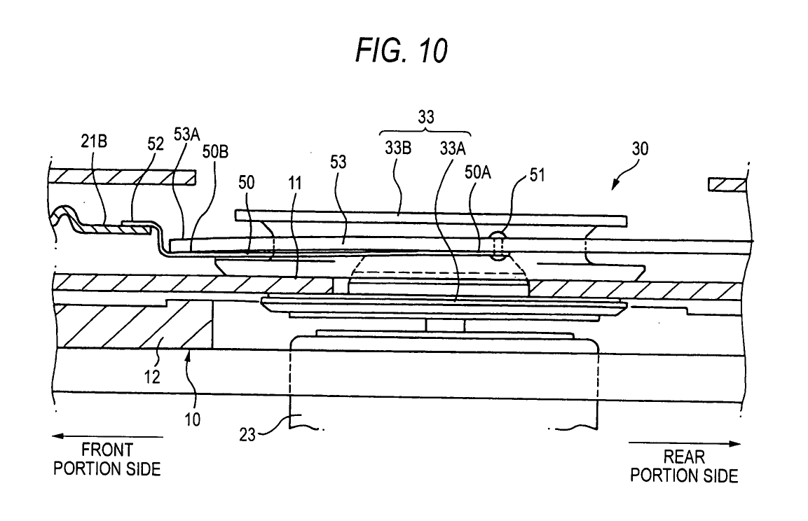

Then, the disk loading device 30 causes the turntable 33A attached to the rotating shaft of the drive unit 23 to approach the clamper 33B at the access position by means of the lifting means 32. At the same time, the disk loading device 30 causes the clamper 33B to be attracted to the turntable 33A by the magnetic force while rotating the clamper holder 53 toward the turntable 33A, thereby holding the disk 11 at a position where it does not come into contact with inner wall surfaces of the cartridge 12 (the state shown in FIG. 10).

At this time, the clamper 33B remains mounted on the disk 11, and is rotatable as the restriction by the clamper holder 53 has been slightly alleviated.

The retaining portion 52 of the supporter 50 is supported by the top plate 21B by being retained on the upper surface of the top plate 21B. This prevents the lowering of the clamper holder 53 in the direction toward the turntable 33A from the predetermined position.

After the recording or reproduction has been completed, when the turntable 33A starts lowering while releasing the disk 11 to secure a clearance for allowing the cartridge body 10 to be unloaded in the back-and-forth direction, the clamper 33B tends to be lowered together with the turntable 33A.

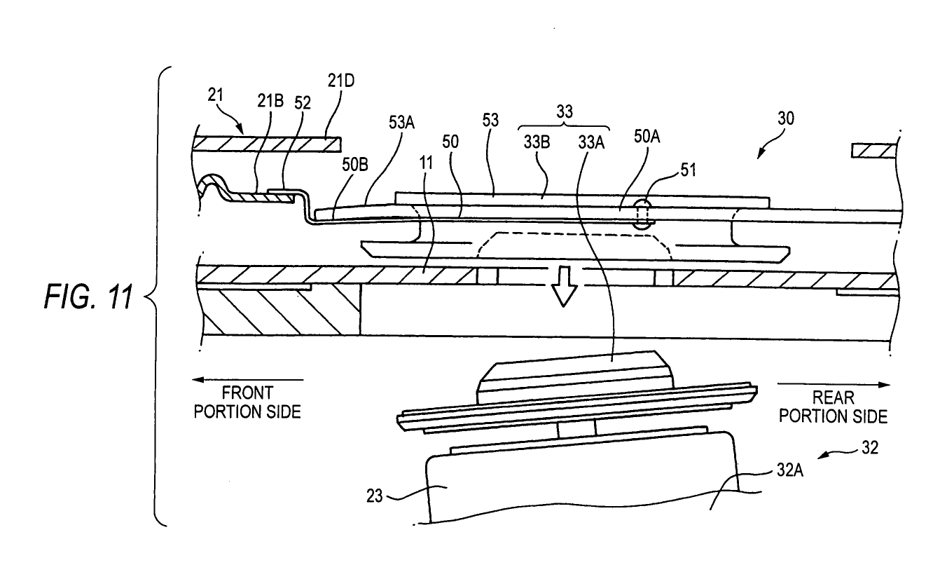

In this state, when the turntable 33A is further lowered, a downwardly pulling force (see the arrow in FIG. 11) is applied to the clamper 33B by the attracting force between the turntable 33A and the clamper 33B.

At this time, the clamper 33B abuts against the upper surface of the clamper holder 53, and the clamper holder 53 is brought into close contact with the upper surface of the supporter 50, while the retaining portion 52 of the supporter 50 abuts against the upper surface of the top plate 21B. Accordingly, the clamper 33B is held at the position where it abuts against the clamper holder 53.

Consequently, the turntable 33A can be stably pulled off the clamper 33B.

When the turntable 33A is pulled off the clamper 33B, the clamper 33B which tends to be lowered by the attracting force is received by the top plate 21B by causing the retaining portion 52 to abut against the top plate 21B. Accordingly, the turntable 33A can be stably pulled off the clamper 33B.

For instance, the retaining portion 52 may be extended straightly from the supporter 50 insofar as the retaining portion 52 can abut against the top plate 21B.

After the lowered turntable 33A has been positively removed from the clamper 33B, the clamper holder 53 is lifted. At this time, since the downwardly attracting force is not applied to the clamper 33B, the load applied to the clamper holder 53 is only the weight (several grams) of the clamper 33B. Therefore, the clamper holder 53 and the clamper 33B can be lifted without an excessive force.

With the lift of the clamper holder 53, the supporter 50 is also lifted. As a result, the retaining portion 52 of the supporter 50 abuts against a lower portion 21D of the housing 21. In this state, the clamper holder 53 is continued to be lifted.

At this time, the supporter 50 is resiliently deformed and remains stationary at the position of its abutment. Accordingly, the clamper holder 53 is lifted from the position where the supporter 50 abutted, and the clamper 33B is lifted together with the clamper holder 53.

The clamper holder 53 lifts until the clamper holder 53 abuts against the lower portion 21D of the housing 21. In this state, the clamper holder 53 stops to lift, as shown in FIG. 9. Therefore, the clamper holder 53 does not project upwardly from the lower portion 21D of the housing 21.

Thus, as the clamper holder 53 is lifted until it abuts against the lower portion 21D of the housing 21, the clamper 33B can be lifted to the predetermined position by the clamper holder 53. Consequently, by lifting the lower end portion of the clamper 33B to an upper position for positioning the cartridge body 10, it is possible to secure a sufficient loading space so that the cartridge body 10 will not interfere with the clamper 33B at the time of loading the cartridge body 10.

According to the embodiment, as the supporter 50 is formed of a resiliently deformable plate material, the clamper holder 53 can be lifted in the state that the supporter 50 is kept stationary at the position of its abutment against the lower portion 21D of the housing 21.

Accordingly, the clamper 33B can be lifted to the predetermined position by the clamper holder 53 without causing the supporter 50 to project from the lower portion 21D of the housing 21.

Consequently, since a sufficient loading space can be secured without causing the clamper holder 53 and the supporter 50 to project from the lower portion 21D of the housing 21, the device can be made compact.

In addition, when the turntable 33A is lowered to be pulled off the clamper 33B, the retaining portion 52 of the supporter 50 is caused to abut against the upper surface of the top plate 21B. As a result, the clamper holder 53 can be supported by the top plate 21B.

Consequently, the turntable 33A can be stably pulled off the clamper 33B.

In addition, as the supporter 50 is formed with a substantially crank-shaped cross section, the positioning accuracy of the clamper holder 53 can be enhanced, as well as the positioning accuracy of the clamper 33B can also be enhanced further.

Furthermore, since the supporter 50 is resilient, the clamper holder 53 can be lifted with a simple construction in the state that the supporter 50 is kept stationary at the position of its abutment against the lower portion 21D of the housing 21 when the clamper holder 53 is lifted.

Although a disk accommodated in the cartridge is used as the disk in the embodiment, it goes without saying that the invention is also applicable to a disk loading device for loading a so-called bare disk in which the disk is not accommodated in the cartridge.

What is claimed is:

1. A disk loading device comprising:
a tray having a mounting surface capable of mounting a disk thereon and supported by a housing of a recording and/or reproducing apparatus; and
a clamp unit which holds the disk at a predetermined height at a position where said tray is accommodated in said housing, said clamp unit having a turntable for lifting a circular center portion of the disk from below, a clamper supported by said housing through a clamper holder provided in said housing and adapted to move away from or attract said turntable by being lifted or lowered as said clamper holder rotates with respect to said housing, and a supporter connected to said clamper holder and adapted to abut on a fixing member provided in said housing,
wherein said supporter restricts a rotational range of said clamper holder.

2. The disk loading device according to claim 1, wherein said supporter has a crank-shaped cross section.

3. The disk loading device according to claim 1, wherein said supporter is resilient.

4. The disk loading device according to claim 1, wherein the disk is accommodated in a cartridge.

5. A disk loading device, comprising:
a tray having a mounting surface capable of mounting a disk thereon and supported by a housing of a recording and/or reproducing apparatus;
a turntable lifting a circular center portion of the disk from below in order to hold the disk at a predetermined height at a position where said tray is accommodated in said housing;
a clamper supported by said housing through a clamper holder provided in said housing and adapted to move away from or attract the turntable by being lifted or lowered as said clamper holder rotates with respect to said housing; and
a supporter connected to said clamper holder and adapted to abut on a fixing member provided in said housing, said supporter restricts a rotational range of said clamper holder.
